(19) United States
(12) Patent Application Publication
(10) Pub. No.: US 2024/0047108 A1
(43) Pub. Date: Feb. 8, 2024

(54) MAGNETIC MATERIAL, ELECTROMAGNETIC COMPONENT, AND METHOD FOR MANUFACTURING MAGNETIC MATERIAL

(71) Applicant: Murata Manufacturing Co., Ltd., Nagaokakyo-shi (JP)

(72) Inventors: Masanori ABE, Nagaokakyo-shi (JP); Takeshi TORITA, Nagaokakyo-shi (JP); Kojiro KOMAGAKI, Nagaokakyo-shi (JP)

(21) Appl. No.: 18/489,449

(22) Filed: Oct. 18, 2023

Related U.S. Application Data
(63) Continuation of application No. PCT/JP22/18564, filed on Apr. 22, 2022.

(30) Foreign Application Priority Data
Jun. 10, 2021 (JP) 2021-097470

(51) Int. Cl. H01F 1/20; H01F 41/14; C22C 14/00; B22F 1/054; B22F 7/00

(52) U.S. Cl. CPC H01F 1/20; H01F 41/14; C22C 14/00; B22F 1/054; B22F 7/00; B22F 2999/00; B22F 2998/10; B22F 2301/205; C22C 2202/02

(57) ABSTRACT

A magnetic material that includes: particles of a layered material including one or more layers and magnetic metal ions in contact with the one or more layers, wherein the one or more layers include a layer body represented by: MₘXₙ, wherein M is at least one metal of Group 3, 4, 5, 6, or 7, X is a carbon atom, a nitrogen atom, or a combination thereof, n is not less than 1 and not more than 4, and m is more than n but not more than 5, and a modifier or terminal T is present on a surface of the layer body, wherein T is at least one selected from a hydroxyl group, a fluorine atom, a chlorine atom, an oxygen atom, and a hydrogen atom, and wherein the particles have an average value of thickness of not less than 1 nm and not more than 10 nm.

### CROSS REFERENCE TO RELATED APPLICATIONS

The present application is a continuation of International application No. PCT/JP2022/018564, filed Apr. 22, 2022, which claims priority to Japanese Patent Application No. 2021-097470, filed Jun. 10, 2021, the entire contents of each of which are incorporated herein by reference.

### TECHNICAL FIELD

The present invention relates to a magnetic material, an electromagnetic component, and a method for manufacturing a magnetic material.

### BACKGROUND ART

In recent years, MXene, graphene, black phosphorus, and the like have attracted attention as layered materials having a form of one or more layers, so-called two-dimensional materials. MXene is a novel material having conductivity, and is a layered material having a form of one or more layers as described later. In general, MXene is in the form of particles (which can include powders, flakes, nanosheets, and the like) of such a layered material.

Currently, various studies are being conducted toward the application of MXene to various electrical devices. For the above-described application, it is required to enhance the characteristics such as conductivity and strength of the material containing MXene. As a part of the study, attempts have been made to insert metal ions into MXene. For example, Patent Document 1 proposes that a powder obtained by bringing MXene not subjected to delamination treatment into contact with a metal salt is attained. Patent Document 2 proposes that a powder obtained by mixing MXene and iron oxide is attained.
Patent Document 1: CN-A-111629575
Patent Document 2: CN-A-110591641

### SUMMARY OF THE INVENTION

However, according to the study of the inventors or the present invention, in the composite material into which metal ions are introduced by the methods of Patent Document 1 or 2, MXene is not delaminated, and layered particles in which a plurality of layers are thickly overlapped are randomly present, and it is considered that the orientation of the layered particles is not necessarily sufficient and the contact area between the layered particles and the metal ions is not sufficiently large in the whole of the composite material. Perhaps because of this, the composite material does not have sufficiently satisfactory conductivity or magnetic properties. In addition, formability as a membrane has not been confirmed.

An object of the present invention is to provide a magnetic material having excellent orientation of layered particles, capable of exhibiting magnetic properties and conductivity, and also having good formability as a membrane.

The present disclosure comprises the following embodiments.

[1] A magnetic material comprising:
particles of a layered material including one or more layers and magnetic metal ions in contact with the one or more layers,
wherein the one or more layers comprise a layer body represented by:

MₘXₙ
wherein M is at least one metal of Group 3, 4, 5, 6, or 7,
X is a carbon atom, a nitrogen atom, or a combination thereof,
n is not less than 1 and not more than 4, and
m is more than n but not more than 5, and
a modifier or terminal T is present on a surface of the layer body, wherein T is at least one selected from the group consisting of a hydroxyl group, a fluorine atom, a chlorine atom, an oxygen atom, and a hydrogen atom,
wherein the particles of the layered material have an average value of thickness of not less than 1 nm and not more than 10 nm.

[2] The magnetic material according to [1], wherein the magnetic metal ions are present between adjacent layers of the one or more layers.

[3] The magnetic material according to [1] or [2], wherein the magnetic material has a maximum saturation magnetization of 0.01 emu/cm³ or more.

[4] The magnetic material according to any one of [1] to [3], wherein the magnetic metal ions are Fe ions and/or Co ions.

[5] The magnetic material according to any one of [1] to [4], wherein the MmXn is represented by Ti₃C₂.

[6] The magnetic material according to any one of [1] to [5], wherein the magnetic material has a conductivity of 500 S/cm or more.

[7] A magnetic membrane or a magnetic structure comprising the magnetic material according to any one of [1] to [6].

[8] A magnetic article comprising the magnetic membrane or the magnetic structure according to [7]

[9] A method for manufacturing a magnetic membrane or a magnetic structure, the method comprising:
bringing particles of a layered material including one or more layers into contact with magnetic metal ions; and
forming a membrane or a structure from a slurry including at least the particles of the layered material,
wherein the one or more layers comprise a layer body represented by:

MₘXₙ
wherein M is at least one metal of Group 3, 4, 5, 6, or 7,
X is a carbon atom, a nitrogen atom, or a combination thereof,
n is not less than 1 and not more than 4, and
m is more than n but not more than 5, and
a modifier or terminal T is present on a surface of the layer body, wherein T is at least one selected from the group consisting of a hydroxyl group, a fluorine atom, a chlorine atom, an oxygen atom, and a hydrogen atom, and
the particles of the layered material have an average value of thicknesses of not less than 1 nm and not more than 10 nm.

[10] The method for manufacturing a magnetic membrane or a magnetic structure according to [9], wherein the slurry contains the particles of the layered material in contact with the magnetic metal ions.

[11] The method for manufacturing a magnetic membrane or a magnetic structure according to [9] or [10], wherein the membrane or the structure is formed containing the particles of the layered material and then the magnetic metal ions are brought into contact with the one or more layers.

According to the present invention, it is possible to provide a magnetic material having excellent orientation of layered particles, capable of exhibiting magnetic properties and conductivity, and also having good formability as a membrane.

### BRIEF DESCRIPTION OF THE DRAWINGS

FIGS. 1(a) and 1(b) include schematic sectional views showing MXene which is a layered material usable for a magnetic material in one embodiment of the present invention, in which FIG. 1(a) shows a single-layer Mxene, and FIG. 1(b) shows a multilayer (exemplarily, two layers) Mxene.

FIG. 2 is a schematic explanatory view of a mechanism of orientation of a magnetic material of the present invention, showing an Mxene membrane (magnetic material) containing magnetic metal ions.

FIG. 3 is a view for explaining an interlayer distance in a transition element-containing Mxene particle according to the present invention.

FIGS. 4(a) and 4(b) include appearance photographs of magnetic membranes according to the present invention, in which FIG. 4(a) is an appearance photograph of a magnetic membrane obtained in Example 3, and FIG. 4(b) is an appearance photograph of a magnetic membrane obtained in Comparative Example 2.

FIG. 5 is a magnetic hysteresis obtained by measuring a magnetic susceptibility of a magnetic material obtained in Example 1.

### DETAILED DESCRIPTION OF THE PREFERRED EMBODIMENTS

### First Embodiment: Magnetic Material

Hereinafter, a magnetic material in one embodiment of the present invention will be described in detail, but the present invention is not limited to such an embodiment.

The magnetic material in the present embodiment comprises particles of a layered material including one or more layers and magnetic metal ions.

The one or more layers of the layered material comprises a layer body represented by a formula shown below:

MₘXₙ
wherein M is at least one metal of Group 3, 4, 5, 6, or 7,
X is a carbon atom, a nitrogen atom, or a combination thereof,
n is not less than 1 and not more than 4, and
m is more than n but not more than 5, and
a modifier or terminal T is present on a surface of the layer body, wherein T is at least one selected from the group consisting of a hydroxyl group, a fluorine atom, a chlorine atom, an oxygen atom, and a hydrogen atom.

In the present specification, the layered material containing no magnetic metal ion is referred to as “Mxene”, and its particles are referred to as “Mxene particles”. In order to distinguish particles in which magnetic metal ions are present between two adjacent layers in Mxene particles from Mxene containing no magnetic metal ion, the particles may be referred to as “magnetic metal ion-containing Mxene particles”.

The layered material may be understood as a layered compound and is also denoted “MₘXₙTₛ”, wherein s is any number, and conventionally x or z may be used instead of s. Typically, n may be 1, 2, 3, or 4, but is not limited to these numbers.

In the above formula of Mxene, M is preferably at least one selected from the group consisting of Ti, Zr, Hf, V, Nb, Ta, Cr, Mo, and Mn, and more preferably at least one selected from the group consisting of Ti, V, Cr, and Mo.

Mxenes whose above formula MₘXₙ is expressed as below are known:
Sc₂C, Ti₂C, Ti₂N, Zr₂C, Zr₂N, Hf₂C, Hf₂N, V₂C, V₂N, Nb₂C, Ta₂C, Cr₂C, Cr₂N, Mo₂C, Mo_{1.3}C, Cr_{1.3}C, (Ti,V)₂C, (Ti,Nb)₂C, W₂C, W_{1.3}C, Mo₂N, Nb_{1.3}C, Mo_{1.3}Y_{0.6}C wherein “1.3” and “0.6” mean about 1.3 (=4/3) and about 0.6 (=⅔), respectively,
Ti₃C₂, Ti₃N₂, Ti₃(CN), Zr₃C₂, (Ti,V)₃C₂, (Ti₂Nb)C₂, (Ti₂Ta)C₂, (Ti₂Mn)C₂, Hf₃C₂, (Hf₂V)C₂, (Hf₂Mn)C₂, (V₂Ti)C₂, (Cr₂Ti)C₂, (Cr₂V)C₂, (Cr₂Nb)C₂, (Cr₂Ta)C₂, (Mo₂Sc)C₂, (Mo₂Ti)C₂, (Mo₂Zr)C₂, (Mo2Hf)C₂, (Mo₂V)C₂, (Mo₂Nb)C₂, (Mo₂Ta)C₂, (W₂Ti)C₂, (W₂Zr)C₂, (W₂Hf)C₂,
Ti₄N₃, V₄C₃, Nb₄C₃, Ta₄C₃, (Ti,Nb)₄C₃, (Nb,Zr)₄C₃, (Ti₂Nb₂)C₃, (Ti₂Ta₂)C₃, (V₂Ti₂)C₃, (V₂Nb₂)C₃, (V₂Ta₂)C₃, (Nb₂Ta₂)C₃, (Cr₂Ti₂)C₃, (Cr₂V2)C₃, (Cr₂Nb₂)C₃, (Cr₂Ta₂)C₃, (Mo₂Ti₂)C₃, (Mo₂Zr₂)C₃, (Mo₂Hf₂)C₃, (Mo₂V₂)C₃, (Mo₂Nb₂)C₃, (Mo₂Ta₂)C₃, (W₂Ti₂)C₃, (W₂Zr₂)C₃, (W₂Hf₂)C₃, (Mo_{2.7}V_{1.3})C₃ wherein “2.7” and “1.3” mean about 2.7 (8/3) and about 1.3 (=4/3), respectively.

Typically in the above formula, M may be titanium or vanadium, and X may be a carbon atom or a nitrogen atom. For example, the MAX phase is Ti₃AlC₂ and Mxene is Ti₃C₂Tₛ (in other words, M is Ti, X is C, n is 2, and m is 3).

It is noted, in the present invention, Mxene may contain remaining A atoms at a relatively small amount, for example, at 10% by mass or less with respect to the original amount of A atoms. The remaining amount of A atoms can be preferably 8% by mass or less, and more preferably 6% by mass or less. However, even when the remaining amount of A atoms exceeds 10% by mass, there may be no problem depending on the application and use conditions of the magnetic material.

The structure corresponding to the skeleton of the particles of the layered material according to the present embodiment is the same between the case of the magnetic metal ion-containing Mxene particles and the case of the Mxene particles containing no magnetic metal ion, except that the interlayer distance of the layered material is increased. Hereinafter, the skeleton of the Mxene particles containing no magnetic metal ion is described, but the same description applies to the skeleton of the magnetic metal ion-containing Mxene particles except that the magnetic metal ions are not shown.

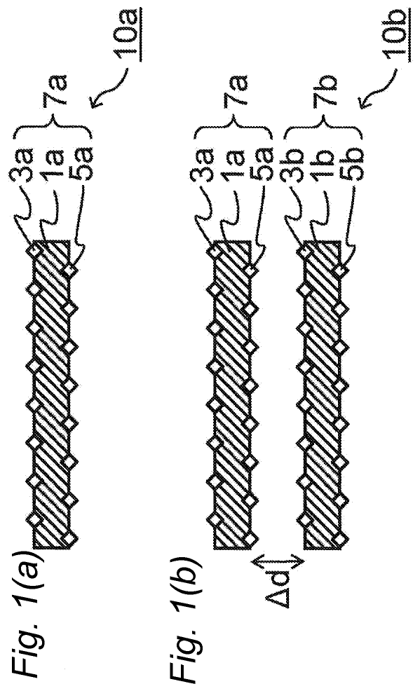

The Mxene particle is an aggregate containing one layer of an Mxene 10a (single-layer Mxene) schematically exemplified in FIG. 1(a). More specifically, the Mxene 10a is an Mxene layer 7a having a layer body (MₘXₙ layer) 1a represented by MₘXₙ and a modifier or terminal T 3a, 5a present on a surface (more specifically, at least one of two surfaces facing each other in each layer) of the layer body 1a. Thus, the Mxene layer 7a is also represented by “MₘXₙTₛ”, and s is any number.

The layered material constituting the magnetic material of the present embodiment may include more than one layers together with one layer. Examples of the Mxene (multilayer Mxene) of more than one layers include, but are not limited to, two layers of Mxene 10b as schematically shown in FIG. 1(b). 1b, 3b, 5b, and 7b in FIG. 1(b) are the same as 1a, 3a, 5a, and 7a in FIG. 1(a) described above. Two adjacent Mxene layers (e.g., 7a and 7b) of the multilayer Mxene do not have to be completely separated from each other, and may be partially in contact with each other. The Mxene 10a may be present in one layer by individually separating the multilayer Mxene 10b, and the unseparated multilayer Mxene 10b may remain. For example, the layered material may be a mixture of the single-layer Mxene 10a and the multilayer Mxene 10b.

Although not limiting the present embodiment, the thickness of each layer of Mxene (which corresponds to the Mxene layers 7a, 7b) is, for example, not less than 0.8 nm and not more than 5 nm, and particularly not less than 0.8 nm and not more than 3 nm (which may vary mainly depending on the number of M atom layers included in each layer). An individual stack of the multilayer Mxene that may be included may have an interlayer distance (or a gap size, indicated by Δd in FIG. 1(b)) of for example, not less than 0.8 nm and not more than 8 nm, particularly not less than 0.8 nm and not more than 5 nm, and more particularly about 1 nm. The thickness and interlayer distance of each layer of Mxene can be measured by, for example, an X-ray diffraction method. The average value of the total number of layers may be not less than 2 and not more than 10.

The Mxene includes Mxene (including a single-layer Mxene and a multilayer Mxene) having a small number of layers obtained through a delamination treatment. The term “small number of layers” means, for example, that the number of stacked layers of Mxene is 10 or less, preferably 6 or less. Hereinafter, the “multilayer Mxene having a small number of layers” may be referred to as a “few-layer Mxene”. The thickness in a stacking direction of the few-layer Mxene is 15 nm or less, preferably 10 nm or less. In addition, the single-layer Mxene and the few-layer Mxene may be collectively referred to as “single-layer/few-layer Mxene”.

By containing the single-layer/few-layer Mxene, the specific surface area of Mxene tends to increase, and as a result, the contact area between the magnetic metal ions and the layered material is large, the orientation is improved, and the magnetic characteristics and the conductivity can be further enhanced. For example, in the particles (all Mxene) of the layered material contained in the magnetic material of the present embodiment, the proportion of the single-layer/few-layer Mxene is preferably 80% by volume or more, more preferably 90% by volume or more, and still more preferably 95% by volume or more. The volume of the single-layer Mxene is more preferably larger than the volume of the few-layer Mxene. In addition, since the true density of Mxene does not greatly vary depending on its existence form, it can be said that the total mass of the single-layer Mxene is more preferably larger than the total mass of the few-layer Mxene. When these relationships are satisfied, it is possible to improve the orientation of the layered material while further increasing the contact area between the layered material and the magnetic metal ions, and thus, it is possible to further improve the performance. In the magnetic material of the present embodiment, it is preferable that the layered material is formed of only the single-layer Mxene from the viewpoint of magnetic characteristics and conductivity.

The average value of the thicknesses of the particles of the layered material is not less than 1 nm and not more than 10 nm. The average value of the thicknesses is preferably 7 nm or less, and more preferably 5 nm or less. In consideration of the thickness of the single-layer Mxene, the lower limit of the particle thickness is 1 nm as described above. The particle thickness corresponds to the thickness of the Mxene layer 7a in FIG. 1 in the case of the single-layer Mxene, and corresponds to the sum of the thickness of the Mxene layer 7a, the gap Δd, and the thickness of the Mxene layer 7b, for example, in the case of two layers as shown in FIG. 1(b) as the multilayer Mxene (preferably the few-layer Mxene). In the present specification, the particle thickness means a length of a layer included in the particle in a stack direction (a direction perpendicular to the layer of the particle).

The total number of layers of particles or the average value of the thicknesses is determined as follows. That is, a photograph is taken using an atomic force microscope (AFM) as in Examples described later, and for 50 Mxene particles freely selected in the photograph, the total number or thickness of layers of each Mxene particle is determined, and an average value is determined.

The average value of the maximum dimension in a plane parallel to the layer of particles is preferably not less than 0.1 μm and not more than 20 m. When the average value of the maximum dimension is preferably 0.1 μm or more, the contact area between the magnetic metal ions and the layered material is larger, and the orientation of the layered material is also improved, and thus, for example, magnetic characteristics and conductivity can improve. On the other hand, for example, from the viewpoint of formability and the like, the average value of the maximum dimension is preferably 20 μm or less, more preferably 15 μm or less, and still more preferably 10 μm or less.

The average value of the maximum dimension in the plane parallel to the layer of particles is determined as follows. That is, a photograph is taken using a scanning electron microscope (SEM) as in Examples described later, and for 50 Mxene particles freely selected in the photograph, the maximum dimension in a direction (plane) parallel to the sheet surface of each Mxene particle is determined, and the average value of the 50 Mxene particles is determined.

The magnetic material of the present embodiment contains magnetic metal ions. The magnetic metal ions preferably represent metal ions exhibiting ferromagnetism or paramagnetism. Examples thereof include ions of a transition metal element such as Mg, Fe, Ni, Co, Cu, or Zn; and ions of rare earth elements. One of the magnetic metal ions may be used, or two or more thereof may be used in combination. Examples of the combination of the two magnetic metal ions include a combination of Fe ions and Co ions. As the magnetic metal ions, in particular, ions of a transition metal element may be used, and in particular, Fe ions, Co ions, or a combination of Fe ions and Co ions may be used.

It is preferable that the magnetic metal ions are in contact with a layer of particles of the layered material and is present between two layers adjacent to each other.

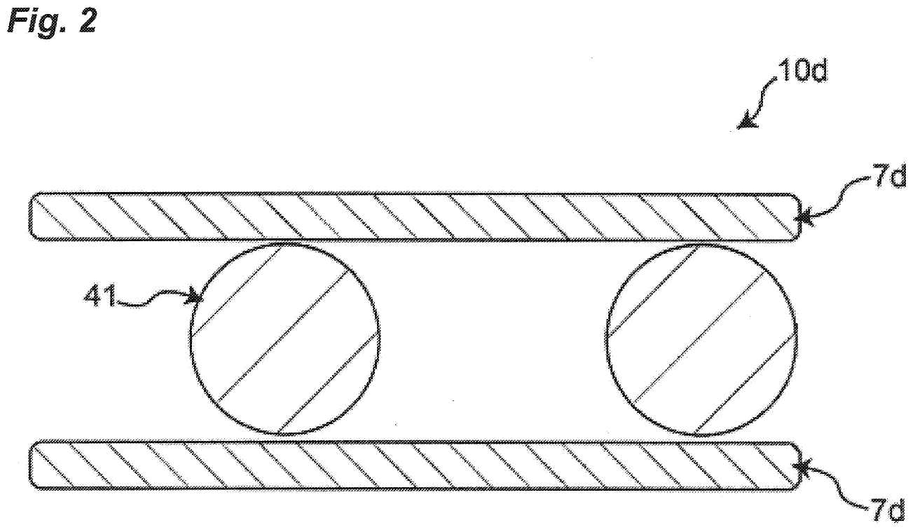

When the magnetic metal ions are, for example, Fe ions, as schematically shown in FIG. 2, it is considered that the magnetic metal ions (in the case of FIG. 2, Fe ions 41) are intercalated between layers 7d of the Mxene particle 10d, Fe ions are supported between the layers 7d of the magnetic metal ion-containing Mxene particle 10d, and the action effect of binding the Fe ions 41 between the layers 7d and 7d is exhibited. As a result, in the conventional magnetic material in which Mxene and a magnetic metal are simply mixed, the contact area between the layer of Mxene particle and the magnetic metal ions and the orientation of the Mxene layer are not sufficient, and the magnetic characteristics, conductivity, and membrane-forming properties are not sufficient. On the other hand, it is considered that the contact area between the layers 7d of the Mxene particle 10d and the magnetic metal ions 41 can be increased, the orientation of the layers 7d of the Mxene particle 10d is improved, the magnetic characteristics and conductivity can be exhibited, and the membrane-forming properties are also improved. Further, it is considered that the magnetic metal ions (in the case of FIG. 2, Fe ions 41) anchoring the layers 7d of the Mxene particle 10d also contributes to ensuring the strength of the magnetic membrane and the magnetic structure formed of the magnetic material. Further, although it is merely a presumption, it is considered that the magnetic metal ions 7d come into contact with the layer constituting the Mxene particle 10d and are preferably present between the layers 7d and 7d constituting the Mxene particle 10d, and thus, the magnetic metal ions (in the case of FIG. 2, Fe ions 41) interact with elements present on the surface of the layers 7d of the Mxene particle 10d while being oriented in a direction parallel to the plane of the layer, which may contribute to improvement of the magnetic characteristics.

In the above description, the interlayer of the multilayer Mxene (particle) has been described as an example, but in the Mxene particle in the present embodiment, “between layers adjacent to each other” is not limited thereto, and for example, it also refers to between the single-layer Mxene (particle) and another single-layer Mxene (particle), between the single-layer Mxene (particle) and the multilayer Mxene (particle), and between the multilayer Mxene (particle) and the multilayer Mxene (particle).

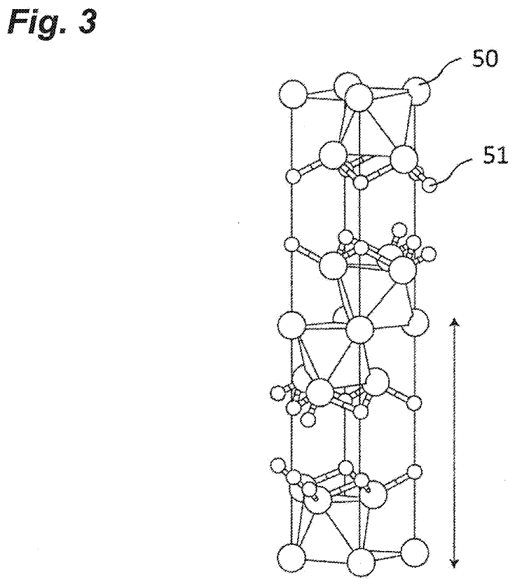

In the magnetic material of the present embodiment, magnetic metal ions are preferably present between the layers constituting Mxene, and the distance between the layers constituting Mxene is shorter than that of the Mxene membrane containing no magnetic metal ion. The above “distance between layers constituting Mxene” refers to a distance indicated by a double-headed arrow in FIG. 3 in the case of Ti₃C₂O₂ (O-term) in which MₘXₙ is represented by Ti₃C₂, where the crystal structure is as schematically shown in FIG. 3 (in FIG. 3, reference 50 denotes a titanium atom, reference 51 denotes an oxygen atom, and other elements are omitted). The distance can be determined by the position (2θ) of a low-angle peak of 11° (deg) or less corresponding to the (002) plane of Mxene in an XRD profile obtained by X-ray diffraction measurement. The higher the peak in the XRD profile is, the narrower the interlayer distance is. The peak refers to a peak top. The X-ray diffraction measurement may be performed under the conditions shown in Examples described later. Examples of the position (2θ) of the low-angle peak include a range of 5° to 110, and among them, the examples include 6.2° or more, and further, 6.3° or more.

In the present specification, a peak in an XRD profile refers to a peak having a peak height of 1/500 or more of a peak corresponding to the (002) plane when a portion having a higher numerical value (that is, having a positive extreme value) than that of one measurement point before and after the measurement point is defined as a peak vertex, and a height when a perpendicular line is drawn from the peak vertex to a baseline is defined as the peak height.

The magnetic metal ion concentration in the magnetic material may be, for example, 0.01 ppm or more, 10 ppm or more, or further, 500 ppm or more on a mass basis, and may be, for example, 50% by mass or less, 20% by mass or less, or further, 10% by mass or less.

The magnetic metal ion content can be measured by ICP-AES using inductively coupled plasma emission spectrometry.

The maximum saturation magnetization of the magnetic material of the present embodiment is, for example, 0.03 emu/cm³ or more, more preferably 0.04 emu/cm³ or more, and may be, for example, 100 emu/cm³ or less, and further, 50 emu/cm³ or less.

The maximum saturation magnetization of the magnetic material can be measured using a vibrating sample magnetometer (VSM).

The conductivity of the magnetic material is preferably, for example, 500 S/cm or more, further preferably 1,000 S/cm or more, particularly preferably 1,500 S/cm more, and may be, for example, 100,000 S/cm or less, and further, 50,000 S/cm or less.

The conductivity of the magnetic material of the present embodiment may be 5000 S/cm or more obtained by substituting the thickness of the magnetic material and the surface resistivity of the magnetic material measured by a four-probe method into the following formula.

Conductivity[S/cm]=1/(thickness[cm] of magnetic material×surface resistivity[Ω/square] of magnetic material)

The thickness of the magnetic material can be measured with a micrometer, a scanning electron microscope, or a stylus type surface profilometer. The method for measuring the magnetic material is determined according to the thickness of the magnetic material. As an indication of adoption of the measurement method, the measurement with a micrometer may be used when the thickness of the magnetic material is thin. A micrometer may be used when the thickness of the magnetic material is 5 μm or more. The measurement with a stylus type surface profilometer is used when the thickness of the magnetic material is 400 μm or less, and the measurement with a scanning electron microscope is used when the thickness of the magnetic material is 200 μm or less and cannot be measured with a stylus type surface profilometer. In the case of measurement with a scanning electron microscope, the measurement magnification may be determined according to the membrane thickness. In the case of measurement with a stylus type profilometer, the measurement is performed with a Dektak (registered trademark) instrument from Veeco Instruments Inc. The thickness of the magnetic material is calculated as an average value.

The magnetic material may have a form as an indeterminate material such as slurry or clay; it may have a form as a determinate material such as a membrane or a structure. The indeterminate material and the determinate material may further include one or more materials of a ceramic, a metal, and a resin material in addition to the magnetic material.

Examples of the ceramic include metal oxides such as silica, alumina, zirconia, titania, magnesia, cerium oxide, zinc oxide, barium titanate-based, hexaferrite, and mullite, and non-oxide ceramics such as silicon nitride, titanium nitride, aluminum nitride, silicon carbide, titanium carbide, tungsten carbide, boron carbide, and titanium boride. Examples of the metal include iron, titanium, magnesium, aluminum, and alloys based on these metals.

Examples of the resin material (polymer) include cellulose-based resins and synthetic polymer-based resins. Examples of the polymer include a hydrophilic polymer (including a hydrophobic polymer mixed with a hydrophilic auxiliary agent to exhibit hydrophilicity and a hydrophobic polymer whose surface is subjected to hydrophilization treatment) and a hydrophobic polymer. Examples of the hydrophilic polymer include those containing one or more selected from the group consisting of polysulfone, cellulose acetate, regenerated cellulose, polyether sulfone, water-soluble polyurethane, polyvinyl alcohol, sodium alginate, an acrylic acid-based water-soluble polymer, polyacrylamide, polyaniline sulfonic acid, and nylon. Examples of the hydrophobic polymer include polyethyleneimine (PEI), polypyrrole (Ppy), polyaniline (PANI), polyimide (PI) containing a secondary amino group, such as a flame-retardant polyimide, and a polymer species having a urethane bond (—NHCO—) such as polyamideimide (PAI), polyacrylamide (PMA), nylon (polyamide resin), DNA (deoxyribonucleic acid) acetanilide, and acetaminophen.

The ratio of the resin material (polymer) contained in the composite material may be appropriately set according to the application. For example, the proportion of the polymer is more than 0% by volume, and may be, for example, 80% by volume or less, further, 50% by volume or less, further, 30% by volume or less, further, 10% by volume or less, and further, 5% by volume or less in terms of the proportion in the composite material (when dried).

The method for manufacturing the composite material is not particularly limited. As an aspect, when the composite material of the present embodiment contains a polymer and has a sheet-like form, for example, as exemplified below, the method may include mixing the magnetic materials and forming a coating film.

First, a magnetic material aqueous dispersion or a magnetic material organic solvent dispersion in which the magnetic material is present in a solvent, or a magnetic material powder may be mixed with a polymer. The solvent of the magnetic material dispersion is typically water, and in some cases, other liquid substances may be contained in a relatively small amount (e.g., 30% by mass or less, preferably 20% by mass or less based on the whole mass) in addition to water.

The magnetic material and the resin material (polymer) may be stirred using a dispersing device such as a homogenizer, a propeller stirrer, a thin film swirling stirrer, a planetary mixer, a mechanical shaker, or a vortex mixer.

To form a sheet of a composite material, a slurry that is a mixture of the magnetic material and a polymer may be applied to a base material (for example, a substrate), but the application method is not limited. Examples thereof include a method of performing spray application using a nozzle such as a one-fluid nozzle, a two-fluid nozzle, or an air brush, a method such as slit coating, screen printing, or metal mask printing using a table coater, a comma coater, or a bar coater, and an application method by spin coating, immersion, or dropping.

The application and drying may be repeated a plurality of times as necessary until a membrane having a desired thickness is obtained. Drying and curing may be performed, for example, at a temperature of 400° C. or less using a normal pressure oven or a vacuum oven.

When the composite material of the present embodiment is a composite material containing a ceramic or a metal, examples of a method for manufacturing the composite material include a method in which a particulate magnetic material is mixed with, for example, a particulate ceramic or metal, and the mixture is heated at a low temperature at which the composition of the magnetic material can be maintained.

Further, the indeterminate material may include a dispersion medium and the like in addition to a magnetic material.

Examples of the dispersion medium include water; and organic media such as N-methylpyrrolidone, N-methylformamide, N,N-dimethylformamide, methanol, ethanol, dimethylsulfoxide, ethylene glycol, and acetic acid.

The magnetic material of the present embodiment, and a magnetic membrane and a magnetic structure containing the magnetic material may be used for any appropriate application as a magnetic article. For example, it may be used in applications where magnetic properties are required, such as electromagnetic shielding (EMI shielding), inductors, reactors, motors, magnetic sensors, magnetic storage media, and the like in any suitable electrical and magnetic devices.

### Second Embodiment: Method for Manufacturing Magnetic Membrane or Magnetic Structure

Hereinafter, a method for manufacturing a magnetic material in an embodiment of the present invention will be described in detail, but the present invention is not limited to such an embodiment.

A method for manufacturing a magnetic membrane or a magnetic structure according to an embodiment includes the steps of
(p) bringing particles of a layered material including one or more layers into contact with magnetic metal ions; and
(q) forming a magnetic membrane or a magnetic structure from a slurry including at least the particles of the layered material,
in which the one or more layers include a layer body represented by a formula shown below:

MₘXₙ
wherein M is at least one metal of Group 3, 4, 5, 6, or 7,
X is a carbon atom, a nitrogen atom, or a combination thereof,
n is not less than 1 and not more than 4, and
m is more than n but not more than 5, and
a modifier or terminal T is present on a surface of the layer body, wherein T is at least one selected from the group consisting of a hydroxyl group, a fluorine atom, a chlorine atom, an oxygen atom, and a hydrogen atom, and
the particles of the layered material have an average value of thicknesses of not less than 1 nm and not more than 10 nm.

Hereinafter, the particles of the layered material used in Steps (p) and (q) may be referred to as “single-layer/few-layer Mxene particles”. That is, it can be said that in Step (p), the single-layer/few-layer Mxene particles are brought into contact with magnetic metal ions, and in Step (q), a magnetic membrane or a magnetic structure is formed from a slurry containing at least the single-layer/few-layer Mxene particles. The magnetic membrane may be simply referred to as “membrane”, and the magnetic structure may be simply referred to as “structure”.

Step (p)

The single-layer/few-layer Mxene particles are brought into contact with magnetic metal ions. For example, a solution containing magnetic metal ions may be brought into contact with the single-layer/few-layer Mxene particles. The contact method may be mixing of the single-layer/few-layer Mxene particles with a solution containing magnetic metal ions, and when the single-layer/few-layer Mxene particles are present in a membrane or a structure, the contact method may be application to the membrane or the structure, particularly immersion of the membrane or the structure in the solution containing magnetic metal ions.

The solution containing magnetic metal ions preferably contains a compound containing the magnetic metal and a solvent. Examples of the compound containing the magnetic metal include salts containing the magnetic metal, and for example, it is preferable to use one or more inorganic acid salts selected from the group consisting of sulfate, nitrate, acetate, and phosphate of the magnetic metal, and nitrate and acetate are more preferable. As the counter anion source, the inorganic acid salt may be used, but an acid does not have to be essential.

The concentration of the compound in the solution may be, for example, 0.001 M or more, or 0.01 M or more, and may be, for example, 0.5 M or less, or 0.2 M or less.

The amount of the compound may be, for example, 0.1 mol or more, 0.5 mol or more, or 1 mol or more, and may be, for example, 10 mol or less, 5 mol or less, or 2 mol or less, based on 100 g of the single-layer/few-layer Mxene.

Examples of the solvent include water (for example, purified water such as distilled water and deionized water); lower alcohol-based solvents having about 2 to 4 carbon atoms (for example, ethanol, isopropyl alcohol, and butanol); hydrocarbon-based solvents such as hexane; and ketone-based solvents such as acetone, and water is preferable.

Examples of the application method include coating methods such as immersion, brush, roller, roll coater, air spray, airless spray, curtain flow coater, roller curtain coater, die coater, and electrostatic coating.

After the application (in particular, immersion), for example, the obtained material may be washed with water and then dried. The drying temperature may be 10 to 160° C., and the drying time may be 1 to 50 hours. The drying may be performed in two stages of low-temperature drying and high-temperature drying, the drying temperature in the low-temperature drying may be 10 to 50° C., and the drying temperature in the high-temperature drying may be 60 to 160° C.

Step (q)

A membrane or a structure is formed from a slurry containing at least the single-layer/few-layer Mxene particles. The slurry may contain only single-layer/few-layer Mxene particles on which no magnetic metal ion is supported, or may contain single-layer/few-layer Mxene particles on which magnetic metal ions are supported.

The concentration of the single-layer/few-layer Mxene particles or the single-layer/few-layer Mxene particles carrying magnetic metal ions in the slurry may be, for example, 5 mg/mL or more, 10 mg/mL or more, 20 mg/mL or more, or 30 mg/mL or more, and may be 200 mg/mL or less. The higher the concentration, the easier it is to thicken the membrane or the structure, which is suitable for industrial mass production. The concentration of the single-layer/few-layer Mxene particles on which the magnetic metal ions may be supported is understood as a solid content concentration in the slurry, and the solid content concentration may be measured using, for example, a heating dry weight measurement method, a freeze dry weight measurement method, a filtration weight measurement method, or the like.

The slurry may be a dispersion liquid and/or a suspension liquid containing, in a liquid medium, single-layer/few-layer Mxene on which magnetic metal ions may be supported. The liquid medium may be an aqueous medium and/or an organic medium, and is preferably an aqueous medium. The aqueous medium is typically water, and in some cases, other liquid substances may be contained in a relatively small amount (e.g., 30% by mass or less, preferably 20% by mass or less based on the whole mass of the aqueous medium) in addition to water. Examples of the organic medium may include N-methylpyrrolidone, N-methylformamide, N,N-dimethylformamide, methanol, ethanol, dimethylsulfoxide, ethylene glycol, and acetic acid.

The method of forming a membrane or a structure from the slurry may be suction filtration, spray coating, screen printing, bar coating, or the like.

The membrane or the structure may be formed on a base material. The base material may be made of any suitable material. Examples of the base material may include a resin membrane, a metal foil, a printed wiring board, a mount electronic component, a metal pin, a metal wiring, and a metal wire.

After the formation of the membrane or the structure, the membrane or the structure is preferably dried. Drying may be performed under mild conditions such as natural drying (typically, it is disposed in an air atmosphere at normal temperature and normal pressure) and air drying (blowing air), or may be performed under relatively active conditions such as hot air drying (blowing heated air), heat drying, and/or vacuum drying.

Step (p) and Step (q) may be performed in any order. For example, Step (q) may be performed after Step (p), or Step (p) may be performed after Step (q).

That is, in an aspect, in Step (p), it is preferable to bring particles of a layered material present in the membrane or the structure into contact with magnetic metal ions, and the manufacturing method in this aspect includes the steps of.
(q1) forming a membrane or a structure from a slurry containing particles of the layered material; and
(p1) bringing particles of a layered material present in the membrane or the structure into contact with magnetic metal ions.

Even after the membrane or the structure is formed, the magnetic metal ions can be brought into contact with the particles of the layered material, preferably introduced between the layers of the particles of the layered material, probably because the particles of the layered material are single-layer/few-layer Mxene particles, which attracts attention.

Step (q1)

As the step of forming a membrane or a structure from the slurry containing particles of the layered material, any of the conditions described above in the description of Step (p) may be adopted.

Step (p1)

In Step (p1), magnetic metal ions are introduced into the membrane or the structure. Examples of the method for bringing the layered material particles into contact with the magnetic metal ions include a method of bringing the layered material particles into contact with a solution containing the single-layer/few-layer Mxene particles and the magnetic metal ions as in Step (p). As the compound containing the magnetic metal and the solvent used in the solution containing magnetic metal ions, the compound and the solvent described above in the description of Step (p) may be used so as to have the concentration or the amount with respect to the single-layer/few-layer Mxene.

Among the methods described above, examples of the method of bringing the single-layer/few-layer Mxene particles into contact with the solution containing magnetic metal ions include application, in particular, immersion, of a solution containing single-layer/few-layer Mxene particles and magnetic metal ions.

After the particles of the layered material and the magnetic metal ions are brought into contact with each other, drying may be performed by the method described above in the description of Step (p).

In another aspect, in Step (q), it is preferable to use a slurry containing particles of the layered material after being brought into contact with the magnetic metal ions, and the manufacturing method in this aspect includes the steps of:
(p2) bringing particles of a layered material including one or more layers into contact with magnetic metal ions to obtain particles of the layered material (hereinafter, it may be referred to as “magnetic metal ion-supporting Mxene particles”) in which the magnetic metal ions are in contact with the layers; and
(q2) forming a membrane or a structure from a slurry containing the magnetic metal ion-supporting Mxene particles.

Even the particles of the layered material after being brought into contact with the magnetic metal ions have the favorable membrane-forming properties and formability, probably because the particles of the layered material are single-layer/few-layer Mxene particles. In addition, since the resulting magnetic material exhibits conductivity, it is also suggested that the orientation of the layer of Mxene particles is favorable, which attracts attention.

Step (p2)

Examples of the method for bringing the layered material particles into contact with the magnetic metal ions in Step (p2) include a method of bringing the layered material particles into contact with a solution containing the single-layer/few-layer Mxene particles and the magnetic metal ions as in Step (p). As the compound containing the magnetic metal and the solvent used in the solution containing magnetic metal ions, the compound and the solvent described above in the description of Step (p) may be used so as to have the concentration or the amount with respect to the single-layer/few-layer Mxene.

Among the methods described above, examples of the method of bringing the single-layer/few-layer Mxene particles into contact with the solution containing magnetic metal ions particularly include mixing of a solution containing single-layer/few-layer Mxene particles and magnetic metal ions.

After the particles of the layered material and the magnetic metal ions are brought into contact with each other, drying may be performed by the method described above in the description of Step (p).

Step (q2)

A slurry may be prepared, and a membrane or a structure may be formed by the same method as the method described above in the description of Step (q).

The single-layer/few-layer Mxene may be manufactured, for example, by the following method (first manufacturing method). The first manufacturing method includes:
(a) preparing a precursor represented by a formula shown below:

MₘAXₙ
wherein M is at least one metal of Group 3, 4, 5, 6, or 7,
X is a carbon atom, a nitrogen atom, or a combination thereof,
A is at least one element of Group 12, 13, 14, 15, or 16,
n is not less than 1 and not more than 4, and
m is more than n but not more than 5,
(b1) performing an etching treatment for removing some A atoms from the precursor using an etching solution;
(c1) washing the etching product obtained by the etching treatment with water;
(d1) performing an intercalation treatment of monovalent metal ions, the intercalation treatment including a step of mixing a water washing treatment product obtained by the washing with water with a metal compound containing the monovalent metal ions;
(e) performing a delamination treatment including a step of stirring an intercalation product obtained by performing the intercalation treatment of the monovalent metal ions; and
(f) washing the delamination product obtained by the delamination treatment with water to obtain single-layer/few-layer MXene particles.

The single-layer/few-layer MXene particles may also be manufactured by the following method (second manufacturing method). The second manufacturing method includes:
(a) preparing a precursor represented by a formula shown below:

MₘAXₙ
wherein M is at least one metal of Group 3, 4, 5, 6, or 7,
X is a carbon atom, a nitrogen atom, or a combination thereof,
A is at least one element of Group 12, 13, 14, 15, or 16,
n is not less than 1 and not more than 4, and
m is more than n but not more than 5,
(b2) performing an etching treatment for removing some A atoms from the precursor by using an etching solution containing a metal compound containing monovalent metal ions, and performing an intercalation treatment of the monovalent metal ions;
(c2) washing an (etching+intercalation) treatment product obtained by performing the etching treatment and the intercalation treatment of the monovalent metal ions with water; and
(e) performing a delamination treatment including a step of stirring a water washing treatment product obtained by the washing with water.

Step (a)

First, a predetermined precursor is prepared. The predetermined precursor that can be used in the present embodiment is a MAX phase that is a precursor of MXene, represented by a formula shown below:

MₘAXₙ
wherein M is at least one metal of Group 3, 4, 5, 6, or 7,
X is a carbon atom, a nitrogen atom, or a combination thereof,
A is at least one element of Group 12, 13, 14, 15, or 16,
n is not less than 1 and not more than 4, and
m is more than n but not more than 5.

M, X, n, and m are as described for MXene. A is at least one element of Group 12, 13, 14, 15, or 16, is usually a Group A element, typically Group IIIA and Group IVA, and more specifically may contain at least one selected from the group consisting of Al, Ga, In, Tl, Si, Ge, Sn, Pb, P, As, S, and Cd, and is preferably Al.

The MAX phase has a crystal structure in which a layer constituted by A atoms is positioned between two layers represented by MₘXₙ (each X may have a crystal lattice positioned in an octahedral array of M). When typically m=n+1, but not limited thereto, the MAX phase includes repeating units in which each one layer of X atoms is disposed in between adjacent layers of n+1 layers of M atoms (these are also collectively referred to as an “MₘXₙ layer”), and a layer of A atoms (“A atom layer”) is disposed as a layer next to the (n+1)th layer of M atoms. The A atom layer (and optionally a part of the M atoms) is removed by selectively etching (removing and optionally layer-separating) the A atoms (and optionally a part of the M atoms) from the MAX phase.

The MAX phase may be manufactured by a known method. For example, a TiC powder, a Ti powder, and an Al powder are mixed in a ball mill, and the resulting mixed powder is fired under an Ar atmosphere to obtain a fired body (block-shaped MAX phase). Thereafter, the fired body obtained is pulverized by an end mill to obtain a powdery MAX phase for the next step.

Step (b1)

In the first manufacturing method, an etching treatment for removing at least some A atoms from the precursor using an etching solution is performed. Conditions for the etching treatment are not particularly limited, and known conditions may be adopted. As described above, the etching may be performed using an etching solution containing F⁻, and examples thereof include a method using hydrofluoric acid, a method using a mixed solution of hydrofluoric acid and hydrochloric acid, and a method using a mixed solution of lithium fluoride and hydrochloric acid. The etching solution may further contain phosphoric acid or the like. In these methods, a mixed solution of the acid or the like and, for example, pure water is used as a solvent. Examples of the etching product obtained by the etching treatment include slurry.

Step (c1)

The etching product obtained by the etching treatment is washed with water. By performing water washing, the acid and the like used in the etching treatment can be sufficiently removed. The amount of water mixed with the etching product and the washing method are not particularly limited. For example, stirring, centrifugation, and the like may be performed by adding water. Examples of the stirring method include stirring using a handshake, an automatic shaker, a share mixer, a pot mill, or the like. The degree of stirring such as the stirring speed and the stirring time may be adjusted according to the amount, concentration, and the like of the acid-treated product to be treated. The washing with water may be performed one or more times. Preferably, washing with water is performed more than once. For example, specifically, Steps (i) to (iii) of (i) adding water (to the etching product or the remaining precipitate obtained in the following (iii)) and stirring, (ii) centrifuging the stirred product, and (iii) discarding the supernatant after centrifugation, are performed within a range of not less than 2 times and, for example, not more than 15 times.

Step (d1)

An intercalation treatment of a monovalent metal is performed, the intercalation treatment including a step of mixing the water washing treatment product obtained by the washing with water with a metal compound containing monovalent metal ions.

Examples of the monovalent metal ions constituting the metal compound containing monovalent metal ions include alkali metal ions such as lithium ions, sodium ions, and potassium ions, copper ions, silver ions, and gold ions. Examples of the metal compound containing monovalent metal ions include an ionic compound in which the metal ions and cations are bonded. Examples of the ionic compound include an iodide, a phosphate, and a sulfate including a sulfide salt, a nitrate, an acetate, and a carboxylate of the above-described metal ions. As described above, the monovalent metal ions are preferably lithium ions, and the metal compound containing the monovalent metal ions is preferably a metal compound containing lithium ions, more preferably an ionic compound of lithium ions, and still more preferably one or more of an iodide, a phosphate, and a sulfide salt of lithium ions. When a lithium ion is used as the metal ion, it is considered that water hydrated to the lithium ion has the most negative dielectric constant, and thus it is easy to form a monolayer.

The content of the metal compound containing monovalent metal ions in the formulation for the intercalation treatment of the monovalent metal ions is preferably 0.001% by mass or more. The content is more preferably 0.01% by mass or more, still more preferably 0.1% by mass or more. On the other hand, from the viewpoint of dispersibility in the solution, the content of the metal compound containing monovalent metal ions is preferably 10% by mass or less, and more preferably 1% by mass or less.

A specific method of the intercalation treatment is not particularly limited, and for example, a metal compound containing monovalent metal ions may be mixed with a moisture medium clay of the MXene and stirred, or may be allowed to stand. Examples of the specific method include stirring at room temperature. Examples of the stirring method include a method using a stirring bar such as a stirrer, a method using a stirring blade, a method using a mixer, and a method using a centrifugal device, and the stirring time may be set according to the production scale of the single-layer/few-layer MXene particles, and for example, the stirring time may be set to 12 to 24 hours.

In the second manufacturing method, in Step (b2), the etching treatment of the precursor and the intercalation treatment of the monovalent metal ions are performed together.

Step (b2)

In the second manufacturing method, at least some A atoms (and optionally some M atoms) are etched (removed and optionally layer separated) from the precursor using an etching solution containing a metal compound containing monovalent metal ions, and an intercalation treatment of the monovalent metal ions is performed.

In the present embodiment, the intercalation treatment of the monovalent metal ions is performed in which the monovalent metal ions are inserted between the MₘXₙ layers at the time of etching (removal and optionally layer separation) at least some A atoms (and optionally some M atoms) from the MAX phase.

As the metal-containing compound containing monovalent metal ions, the ionic compound shown in Step (d1) in the first manufacturing method may be used. The content of the metal compound containing monovalent metal ions in the etching solution is preferably 0.001% by mass or more. The content is more preferably 0.01% by mass or more, still more preferably 0.1% by mass or more. On the other hand, from the viewpoint of dispersibility in the solution, the content of the metal compound containing monovalent metal ions in the etching solution is preferably 10% by mass or less, and more preferably 1% by mass or less.

Other configurations of the etching solution are not particularly limited as long as the etching solution in Step (b2) contains a metal compound containing monovalent metal ions, and known conditions may be adopted. For example, as described in Step (b1), etching may be performed using an etching solution further containing F⁻, and examples thereof include a method using hydrofluoric acid, a method using a mixed solution of hydrofluoric acid and hydrochloric acid, and a method using a mixed solution of lithium fluoride and hydrochloric acid. The etching solution may further contain phosphoric acid or the like. In these methods, a mixed solution of the acid or the like and, for example, pure water is used as a solvent. Examples of the etching product obtained by the etching treatment include slurry.

Step (c2)

The (etching+intercalation) treatment product obtained by performing the etching treatment and the intercalation treatment of the monovalent metal ions is washed with water. The acid and the like used in the (etching+intercalation) treatment can be sufficiently removed by performing water washing. The amount of water to be mixed with the (etching+intercalation) treatment product and the washing method are not particularly limited. For example, stirring, centrifugation, and the like may be performed by adding water. Examples of the stirring method include stirring using a handshake, an automatic shaker, a share mixer, a pot mill, or the like. The degree of stirring such as the stirring speed and the stirring time may be adjusted according to the amount, concentration, and the like of the acid-treated product to be treated. The washing with water may be performed one or more times. Preferably, washing with water is performed more than once. For example, specifically, Steps (i) to (iii) of (i) adding water (to the (etching+intercalation) treatment product or the remaining precipitate obtained in the following (iii)) and stirring, (ii) centrifuging the stirred product, and (iii) discarding the supernatant after centrifugation are performed within a range of not less than 2 times and, for example, not more than 15 times.

Among the first manufacturing method and the second manufacturing method, a manufacturing method in which Step (b1) of etching treatment and Step (d1) of intercalation treatment of the monovalent metal ions are separated as in the first manufacturing method is preferable because MXene can be more easily formed into a single layer.

Step (e)

A delamination treatment is performed including a step of stirring the intercalation product of the monovalent metal ions obtained by the intercalation treatment of the monovalent metal ions in Step (d1) in the first manufacturing method or the water washing treatment product obtained by the washing with water in Step (c2) in the second manufacturing method. By this delamination treatment, the number of layers of MXene can be reduced to a single layer or few layers. Conditions for the delamination treatment are not particularly limited, and the delamination treatment may be performed by a known method. Examples of the stirring method include stirring using ultrasonic treatment, handshaking, and an automatic shaker. The degree of stirring such as the stirring speed and the stirring time may be adjusted according to the amount, concentration, and the like of the product to be treated. For example, the slurry after the intercalation is centrifuged to discard the supernatant, and then pure water is added to the remaining precipitate, then for example, stirring is performed by handshaking or an automatic shaker to perform layer separation. The removal of the unpeeled substance includes a step of performing centrifugal separation to discard the supernatant, and then washing the remaining precipitate with water. For example, (i) pure water is added to the remaining precipitate after discarding the supernatant and stirred, (ii) centrifugation is performed, and (iii) the supernatant is recovered. This operation of (i) to (iii) is repeated 1 time or more, preferably 2 times or more and 10 times or less to obtain a single-layer/few-layer MXene-containing supernatant before acid treatment as a delaminated product. Alternatively, the supernatant may be centrifuged, the supernatant after centrifugation may be discarded, and a single-layer/few-layer MXene-containing clay before acid treatment may be obtained as a delaminated product.

In the manufacturing method of the present embodiment, ultrasonic treatment does not have to be performed as delamination. When the ultrasonic treatment is not performed, particle breakage hardly occurs, and it is easy to obtain single-layer/few-layer MXene particles having a large plane parallel to the layer of particles, that is, a large two-dimensional plane.

The delaminated product obtained by stirring may be used as single-layer/few-layer MXene particles as it is, and may be washed with water as necessary.

Although the magnetic material, the magnetic membrane, the magnetic structure, the article including these, and the method for manufacturing the magnetic membrane and the magnetic structure in the embodiment of the present invention have been described in detail above, various modifications are possible. The magnetic material, the magnetic membrane, and the magnetic structure of the present invention may be manufactured by a method different from the manufacturing method in the above-described embodiments, and the method for manufacturing the magnetic membrane and the magnetic structure of the present invention is not limited only to those providing the magnetic membrane and the magnetic structure in the above-described embodiments.

### EXAMPLES

The present invention will be described more specifically with reference to the following Examples, but the present invention is not limited to these Examples.

[Manufacture of Magnetic Metal Ion-Supporting MXene Membrane]

### Example 1

### Preparation of Single-Layer/Few-Layer MXene Particle

Ti₃AlC₂ particles were prepared as MAX particles by a known method. The Ti₃AlC₂ particles (powder) were added to 9 mol/L hydrochloric acid together with LiF (for 1 g of Ti₃AlC₂ particles, 1 g of LiF and 10 mL of 9 mol/L hydrochloric acid were used), and the resulting material was stirred with a stirrer at 35° C. for 24 hours to obtain a solid-liquid mixture (suspension) containing a solid component derived from the Ti₃AlC₂ particles.

The solid-liquid mixture (suspension) was subjected to operations of washing with pure water and separating and removing a supernatant by decantation using a centrifuge (remaining precipitate from which the supernatant has been removed was washed again) repeatedly about 10 times. Then, the mixture obtained by adding pure water to the precipitate was stirred with an automatic shaker for 15 minutes, and then subjected to centrifugal separation operation for 5 minutes with a centrifuge to separate the mixture into a supernatant and a precipitate, and the supernatant was separated and removed by centrifugal dehydration. Then, dilution was performed by adding pure water to the remaining precipitate from which the supernatant has been removed, whereby a crude purification slurry was obtained.

It is understood that the crude purification slurry may contain, as MXene particles, a single-layer MXene and a multilayer MXene that is not formed into a single layer due to insufficient layer separation (delamination), and further contains impurities other than MXene particles (crystals of unreacted MAX particles and byproducts derived from etched A atoms (for example, crystals of AlF₃), and the like).

The crude purification slurry obtained above was placed in a centrifuge tube, and centrifuged at a relative centrifugal force (RCF) of 2600×g for 5 minutes using a centrifuge. The supernatant thus centrifuged was recovered by decantation to obtain a purified slurry. The purified slurry is understood to be a single-layer MXene in which most of MXene has been delaminated as MXene particles. The remaining precipitate from which the supernatant has been removed was not subsequently used.

Formation of Membrane from Slurry Containing Single-Layer/Few-Layer MXene Particle

The purified slurry obtained above was placed in a centrifuge tube, and centrifuged at a relative centrifugal force (RCF) of 3500×g for 120 minutes using a centrifuge. The supernatant thus centrifuged was separated and removed by decantation. The separated and removed supernatant was not subsequently used. A clay-like substance (clay) was obtained as the remaining precipitate from which the supernatant was removed. A Ti₃C₂Tₛ-water dispersion clay was thus obtained as an MXene clay. The MXene clay and pure water were mixed in appropriate amounts to prepare an MXene slurry having a solid concentration (MXene concentration) of about 34 mg/mL. The MXene aqueous dispersion (MXene solid content concentration: 34 mg/mL) in an amount of 5 mL was taken with a dropper and subjected to suction filtration overnight to obtain a filtration membrane. As the filtration membrane, a membrane filter having a pore size of 0.45 μm (Durapore manufactured by Merck) was used.

Contact Between Single-Layer/Few-Layer MXene Particle and Fe Ion

Next, 2.020 g of iron (III) nitrate nonahydrate (manufactured by FUJIFILM Wako Pure Chemical Corporation) was weighed, and pure water was added thereto so that the total amount was 50 mL to produce a 0.1 M aqueous iron (III) nitrate solution. The MXene filtration membrane produced above was immersed in 20 mL of the produced 0.1 M aqueous iron (III) nitrate solution, and was left to stand at room temperature for 24 hours. After 24 hours, the MXene filtration membrane was taken out from the aqueous iron (III) nitrate solution, and the surface was washed with pure water, then further left to stand at room temperature for 1 day to dry, and then dried in a vacuum oven at 80° C. overnight to obtain a filtration membrane into which iron (III) ions were introduced.

### Example 2

### Preparation of Single-Layer/Few-Layer MXene Particle

Ti₃AlC₂ particles were prepared as MAX particles by a known method. The Ti₃AlC₂ particles (powder) were added to 9 mol/L hydrochloric acid together with LiF (for 1 g of Ti₃AlC₂ particles, 1 g of LiF and 10 mL of 9 mol/L hydrochloric acid were used), and the resulting material was stirred with a stirrer at 35° C. for 24 hours to obtain a solid-liquid mixture (suspension) containing a solid component derived from the Ti₃AlC₂ particles. The obtained mixture was subjected to operations of washing with pure water and separating and removing a supernatant by decantation using a centrifuge (remaining precipitate from which the supernatant has been removed was washed again) repeatedly about 10 times. Then, the mixture obtained by adding pure water to the precipitate was stirred with an automatic shaker for 15 minutes, and then subjected to centrifugal separation operation for 5 minutes with a centrifuge to separate the mixture into a supernatant and a precipitate, and the supernatant was separated and removed by centrifugal dehydration. Then, dilution was performed by adding pure water to the remaining precipitate from which the supernatant has been removed, whereby a crude purification slurry was obtained. It is understood that the crude purification slurry may contain, as MXene particles, a single-layer MXene and a multilayer MXene that is not formed into a single layer due to insufficient layer separation (delamination), and further contains impurities other than MXene particles (crystals of unreacted MAX particles and byproducts derived from etched A atoms (for example, crystals of AlF₃), and the like).

The crude purification slurry obtained above was placed in a centrifuge tube, and centrifuged at a relative centrifugal force (RCF) of 2600×g for 5 minutes using a centrifuge. The supernatant thus centrifuged was recovered by decantation to obtain a purified slurry. The purified slurry is understood to be a single-layer MXene in which most of MXene has been delaminated as MXene particles. The remaining precipitate from which the supernatant has been removed was not subsequently used.

The purified slurry obtained above was placed in a centrifuge tube, and centrifuged at a relative centrifugal force (RCF) of 3500×g for 120 minutes using a centrifuge. The supernatant thus centrifuged was separated and removed by decantation. The separated and removed supernatant was not subsequently used. A clay-like substance (clay) was obtained as the remaining precipitate from which the supernatant was removed. A Ti₃C₂Tₛ-water dispersion clay was thus obtained as an MXene clay. The MXene clay and pure water were mixed in appropriate amounts to prepare an MXene slurry having a solid concentration (MXene concentration) of about 34 mg/mL.

Formation of Membrane from Slurry Containing Single-Layer/Few-Layer MXene Particle

The MXene aqueous dispersion (MXene solid content concentration: 34 mg/mL) in an amount of 10 mL was taken with a dropper and subjected to suction filtration for two nights to obtain a filtration membrane. As the filtration membrane, a membrane filter having a pore size of 0.45 μm (Durapore manufactured by Merck) was used.

Contact Between Single-Layer/Few-Layer MXene Particle and Co Ion

Next, 1.25 g of cobalt (II) acetate tetrahydrate (manufactured by FUJIFILM Wako Pure Chemical Corporation) was weighed, and pure water was added thereto so that the total amount was 50 mL to prepare a 0.1 M aqueous cobalt (II) acetate solution. The MXene filtration membrane produced above was immersed in 20 mL of the produced 0.1 M aqueous cobalt (II) acetate solution, and was left to stand at room temperature for 24 hours. After 24 hours, the MXene filtration membrane was taken out from the aqueous cobalt (II) acetate solution, and the surface was washed with pure water, then further left to stand at room temperature for 1 day to dry, and then dried in a vacuum oven at 80° C. overnight to obtain a filtration membrane into which cobalt (II) ions were introduced.

### Example 3

### Preparation of Single-Layer/Few-Layer MXene Particle

Ti₃AlC₂ particles were prepared as MAX particles by a known method. The Ti₃AlC₂ particles (powder) were added to 9 mol/L hydrochloric acid together with LiF (for 1 g of Ti₃AlC₂ particles, 1 g of LiF and 10 mL of 9 mol/L hydrochloric acid were used), and the resulting material was stirred with a stirrer at 35° C. for 24 hours to obtain a solid-liquid mixture (suspension) containing a solid component derived from the Ti₃AlC₂ particles. The obtained mixture was subjected to operations of washing with pure water and separating and removing a supernatant by decantation using a centrifuge (remaining precipitate from which the supernatant has been removed was washed again) repeatedly about 10 times. Then, the mixture obtained by adding pure water to the precipitate was stirred with an automatic shaker for 15 minutes, and then subjected to centrifugal separation operation for 5 minutes with a centrifuge to separate the mixture into a supernatant and a precipitate, and the supernatant was separated and removed by centrifugal dehydration. Then, dilution was performed by adding pure water to the remaining precipitate from which the supernatant has been removed, whereby a crude purification slurry was obtained. It is understood that the crude purification slurry may contain, as MXene particles, a single-layer MXene and a multilayer MXene that is not formed into a single layer due to insufficient layer separation (delamination), and further contains impurities other than MXene particles (crystals of unreacted MAX particles and byproducts derived from etched A atoms (for example, crystals of AlF₃), and the like).

The crude purification slurry obtained above was placed in a centrifuge tube and centrifuged at a centrifugal force of 2600 rcf for 5 minutes using a centrifuge. The supernatant thus centrifuged was recovered by decantation to obtain a purified slurry. The purified slurry is understood to be a single-layer MXene in which most of MXene has been delaminated as MXene particles. The remaining precipitate from which the supernatant has been removed was not subsequently used.

Contact Between Single-Layer/Few-Layer MXene Particle and Fe Ion

The purified slurry obtained above was placed in a centrifuge tube, and centrifuged at a relative centrifugal force (RCF) of 3500×g for 120 minutes using a centrifuge. The supernatant thus centrifuged was separated and removed by decantation. The separated and removed supernatant was not subsequently used. A clay-like substance (clay) was obtained as the remaining precipitate from which the supernatant was removed. A Ti₃C₂Tₛ-water dispersion clay was thus obtained as an MXene clay. The MXene clay and pure water were mixed in appropriate amounts to prepare an MXene slurry having a solid concentration (MXene concentration) of about 34 mg/mL.

Formation of Membrane from Slurry Containing Single-Layer/Few-Layer MXene Particles on which Fe Ion is Supported

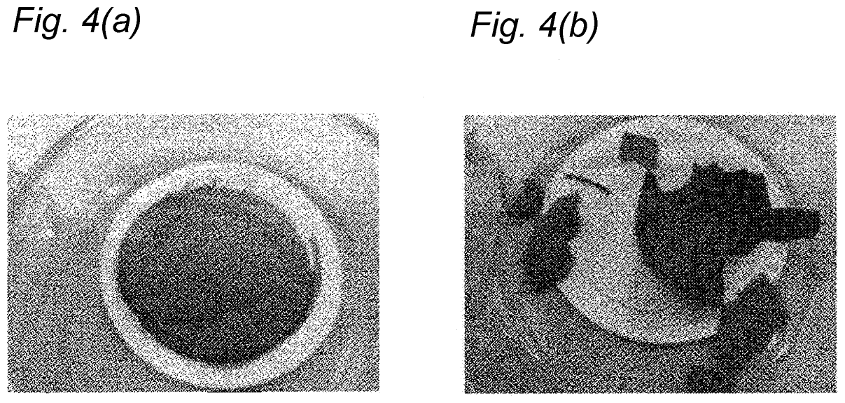

The MXene slurry obtained above in an amount of 10 mL was taken with a dropper and mixed with 30 mL of a 0.1 M aqueous iron nitrate (III) solution produced in the same manner as in Example 1, and thereafter, the mixture was subjected to suction filtration for two nights and washed with pure water to obtain a filtration membrane. As the filtration membrane, a membrane filter having a pore size of 0.45 μm (Durapore manufactured by Merck) was used. The membrane obtained by this method had a well-shaped circular shape (shape of a membrane filter) (FIG. 4(a)). Next, the obtained membrane was left to stand at room temperature for 24 hours, and after 24 hours, left to stand at room temperature for another 1 day, and then dried in a vacuum oven at 80° C. overnight to obtain a filtration membrane into which Fe (III) ions were introduced.

### Comparative Example 1

Ti₃AlC₂ particles were prepared as MAX particles by a known method. The Ti₃AlC₂ particles (powder) were added to 9 mol/L hydrochloric acid together with LiF (for 1 g of Ti₃AlC₂ particles, 1 g of LiF and 10 mL of 9 mol/L hydrochloric acid were used), and the resulting material was stirred with a stirrer at 35° C. for 24 hours to obtain a solid-liquid mixture (suspension) containing a solid component derived from the Ti₃AlC₂ particles. The obtained mixture was subjected to operations of washing with pure water and separating and removing a supernatant by decantation using a centrifuge (remaining precipitate from which the supernatant has been removed was washed again) repeatedly about 10 times. Then, the mixture obtained by adding pure water to the precipitate was stirred with an automatic shaker for 15 minutes, and then subjected to centrifugal separation operation for 5 minutes with a centrifuge to separate the mixture into a supernatant and a precipitate, and the supernatant was separated and removed by centrifugal dehydration. Then, dilution was performed by adding pure water to the remaining precipitate from which the supernatant has been removed, whereby a crude purification slurry was obtained. It is understood that the crude purification slurry may contain, as MXene particles, a single-layer MXene and a multilayer MXene that is not formed into a single layer due to insufficient layer separation (delamination), and further contains impurities other than MXene particles (crystals of unreacted MAX particles and byproducts derived from etched A atoms (for example, crystals of AlF₃), and the like).

The crude purification slurry obtained above was placed in a centrifuge tube, and centrifuged at a relative centrifugal force (RCF) of 2600×g for 5 minutes using a centrifuge. The supernatant thus centrifuged was recovered by decantation to obtain a purified slurry. The purified slurry is understood to contain a large amount of single-layer MXene as MXene particles. The remaining precipitate from which the supernatant has been removed was not subsequently used.

The purified slurry obtained above was placed in a centrifuge tube, and centrifuged at a relative centrifugal force (RCF) of 3500×g for 120 minutes using a centrifuge. The supernatant thus centrifuged was separated and removed by decantation. The separated and removed supernatant was not subsequently used. A clay-like substance (clay) was obtained as the remaining precipitate from which the supernatant was removed. A Ti₃C₂Tₛ-water dispersion clay was thus obtained as an MXene clay. The MXene clay and pure water were mixed in appropriate amounts to prepare an MXene slurry having a solid concentration (MXene concentration) of about 34 mg/mL.

The MXene aqueous dispersion (MXene solid content concentration: 34 mg/mL) in an amount of 5 mL was taken with a dropper and subjected to suction filtration overnight to obtain a filtration membrane. As the filtration membrane, a membrane filter having a pore size of 0.45 μm (Durapore manufactured by Merck) was used. Next, the obtained membrane was left to stand at room temperature for 24 hours, and after 24 hours, left to stand at room temperature for another 1 day, and then dried in a vacuum oven at 80° C. overnight to obtain a control filtration membrane.

### Comparative Example 2

Ti₃AlC₂ particles were prepared as MAX particles by a known method. The Ti₃AlC₂ particles (powder) were added to 9 mol/L hydrochloric acid together with LiF (for 1 g of Ti₃AlC₂ particles, 1 g of LiF and 10 mL of 9 mol/L hydrochloric acid were used), and the resulting material was stirred with a stirrer at 35° C. for 24 hours to obtain a solid-liquid mixture (suspension) containing a solid component derived from the Ti₃AlC₂ particles. The obtained mixture was subjected to operations of washing with pure water and separating and removing a supernatant by decantation using a centrifuge (remaining precipitate from which the supernatant has been removed was washed again) repeatedly about 10 times. Then, the mixture obtained by adding pure water to the precipitate was stirred with an automatic shaker for 15 minutes, and then subjected to centrifugal separation operation for 5 minutes with a centrifuge to separate the mixture into a supernatant and a precipitate, and the supernatant was separated and removed by centrifugal dehydration. Then, dilution was performed by adding pure water to the remaining precipitate from which the supernatant has been removed, whereby a crude purification slurry was obtained. It is understood that the crude purification slurry may contain, as MXene particles, a single-layer MXene and a multilayer MXene that is not formed into a single layer due to insufficient layer separation (delamination), and further contains impurities other than MXene particles (crystals of unreacted MAX particles and byproducts derived from etched A atoms (for example, crystals of AlF₃), and the like).

The crude purification slurry obtained above in an amount of 10 mL was taken with a dropper and mixed with 30 mL of a 0.1 M aqueous iron nitrate (III) solution produced in the same manner as in Example 1, and thereafter, the mixture was subjected to suction filtration for two nights and then washed with pure water to obtain a filtration membrane. As the filtration membrane, a membrane filter having a pore size of 0.45 μm (Durapore manufactured by Merck) was used. Next, the obtained membrane was left to stand at room temperature for 24 hours, and after 24 hours, left to stand at room temperature for another 1 day, and then dried in a vacuum oven at 80° C. overnight to obtain a filtration membrane into which Fe (III) ions were supported on an MXene membrane not subjected to delamination. The membrane obtained by this method was deformed and cracked after drying (FIG. 4(b)).

[Evaluation of Magnetic Metal Ion-Supporting MXene Membrane]

(Measurement of Conductivity)

Using samples of Examples and Comparative Examples, the conductivity was measured and evaluated as follows.

The conductivity was measured at three points including the vicinity of the center of the membrane per sample. For the measurement of the conductivity, a low resistance conductivity meter (Loresta-AX MCP-T370 manufactured by Mitsubishi Chemical Analytech Co., Ltd.) was used. The thickness of the sample (dry membrane) was measured using a micrometer (MDH-25 MB manufactured by Mitutoyo Corporation).

(Measurement of Magnetic Susceptibility)

The magnetic susceptibility was measured using samples of Examples and Comparative Examples.

For the measurement of the magnetic susceptibility, a vibrating sample magnetometer (VSM, Model VSM-5, manufactured by Toei Industry Co., Ltd.) was used. The sample of Example 1 was powdered and placed in a capsule-shaped sample holder to measure the magnetic susceptibility. The samples of Examples 2 and 3 and Comparative Examples 1 and 2 were subjected to magnetic susceptibility measurement in a membrane state. The magnetic sweep direction in measuring the magnetic susceptibility was a long axis direction of the capsule in the sample of Example 1, and a plane direction of the membrane in the samples of Examples 2 and 3 and Comparative Example 2. For the sample of Comparative Example 1, magnetic sweep was performed in both the plane direction and the perpendicular direction of the membrane to measure the magnetic susceptibility. The maximum saturation magnetization was 0.129 emu/cm³ in Example 1, 0.04188 emu/cm³ in Example 2, 0.0545 emu/cm³ in Example 3, no magnetization was able to be detected in Comparative Example 1, and 0.0267 emucm³ in Comparative Example 2.

At present, whether a material is a magnetic body can be determined based on the magnetic hysteresis with the VSM. For example, when the maximum saturation magnetization is a value larger than 0.01 emu/cm³, which is the measurement limit of VSM, by one digit or more, magnetism can be confirmed, and it can be said that the material is a magnetic body.

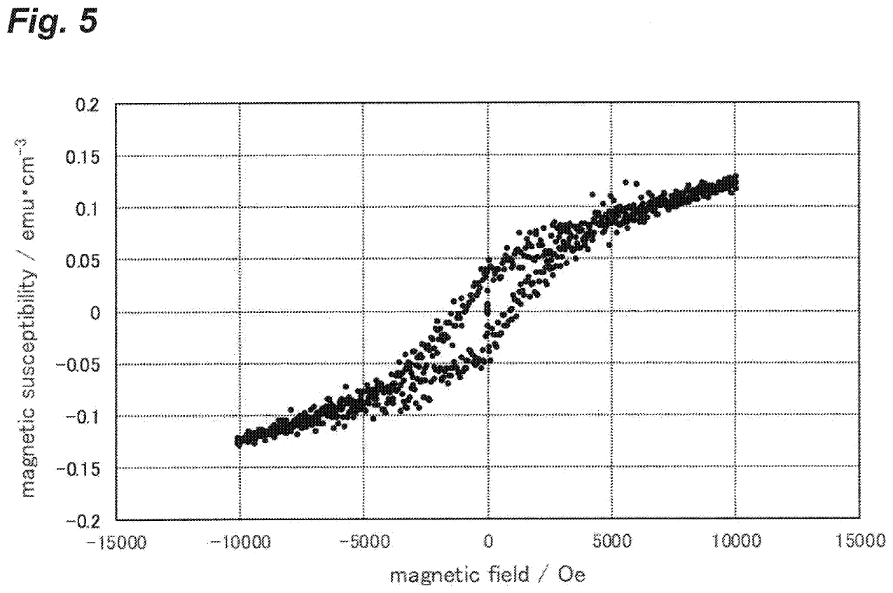

In Example 1, it was confirmed that the maximum saturation magnetization was 0.129 emu/cm³, indicating magnetism (FIG. 5). It is presumed that because MXene is formed into a single-layer/few-layer MXene because of delamination, Fe ions easily penetrate between the MXene layers, Fe ions are easily disposed along the MXene layers, and the contact area with the MXene particles increases, resulting in development of magnetism.

In Example 2, it was confirmed that the maximum saturation magnetization was 0.04188 emu/cm³, indicating magnetism. It is presumed that because MXene is formed into a single-layer/few-layer MXene because of delamination, as in the case of Fe ions, Co ions also easily penetrate between the MXene layers, Co ions are easily disposed along the MXene layers, and the contact area with the MXene particles increases, resulting in development of magnetism.

In Example 3, the maximum saturation magnetization was 0.0545 emu/cm³, indicating magnetism. In addition, the conductivity was 2092 S/cm, indicating conductivity. In addition, in a material using MXene, the conductivity is usually correlated with the orientation of the layer of MXene, and thus it is suggested that the orientation of the layer of MXene is favorable by exhibiting the conductivity.

On the other hand, Comparative Example 1 is an example in which no magnetic metal ion is contained, and magnetism was not able to be confirmed regardless of whether the membrane was magnetically swept in the planar direction or the perpendicular direction.

In Comparative Example 2, the maximum saturation magnetization was 0.0267 emu/cm³, and it was confirmed that magnetism was weak although Fe ions, which are magnetic metal ions, were contained to the same extent as in Examples 1 to 3. In addition, the conductivity was as low as 362 S/cm, suggesting that the orientation of the MXene layer was not favorable. Further, the membrane-forming properties were not favorable probably because MXene not subjected to delamination was used.

Usually, the magnetism derived from a nanostructure is not so strong, and there is a case where the maximum saturation magnetization that can be confirmed by the VSM is not obtained. Thus, it can be said that the fact that magnetic characteristics are obtained by introduction of magnetic metal ions is a characteristic of interest. Further, in the magnetic material according to the present disclosure, magnetic metal ions can be introduced even after a membrane of MXene is formed, and the membrane can be formed even when MXene into which magnetic metal ions are introduced is used, and the conductivity of MXene itself and the orientation and membrane-forming properties of the layer of MXene are not lost. From the above, the magnetic material according to the present disclosure is considered to be useful as a nanometer-scale EMI shield or a magnetic storage medium.

The magnetic material of the present invention may be utilized for any suitable application, and may be particularly preferably used, for example, as an electrode or electromagnetic shield in an electrical device, as an electrode, for example, a large-capacity capacitor, a battery, a bioelectrode with low impedance, a highly sensitive sensor, an antenna, or an electromagnetic shield, for example, particularly preferably, for a high-shielding EMI shield.

### REFERENCE SIGNS LIST

1a, 1b Layer body (MₘXₙ layer)
3a, 5a, 3b, 5b Modifier or terminal T
7a, 7b MXene layer
10, 10a, 10b MXene particles (particles of layered material)
10d MXene particles containing a transition element
41 Fe ion
50 titanium atom
51 oxygen atom

1. A magnetic material comprising:
particles of a layered material including one or more layers and magnetic metal ions in contact with the one or more layers,
wherein the one or more layers comprise a layer body represented by:
MₘXₙ
wherein M is at least one metal of Group 3, 4, 5, 6, or 7,
X is a carbon atom, a nitrogen atom, or a combination thereof,
n is not less than 1 and not more than 4, and
m is more than n but not more than 5, and
a modifier or terminal T is present on a surface of the layer body, wherein T is at least one selected from the group consisting of a hydroxyl group, a fluorine atom, a chlorine atom, an oxygen atom, and a hydrogen atom,
wherein the particles of the layered material have an average value of thicknesses of not less than 1 nm and not more than 10 nm.

2. The magnetic material according to claim 1, wherein the magnetic metal ions are present between adjacent layers of the one or more layers.

3. The magnetic material according to claim 1, wherein the magnetic material has a maximum saturation magnetization of 0.01 emu/cm³ or more.

4. The magnetic material according to claim 1, wherein the magnetic metal ions are Fe ions and/or Co ions.

5. The magnetic material according to claim 1, wherein the MₘXₙ is represented by Ti₃C₂.

6. The magnetic material according to claim 1, wherein the magnetic material has a conductivity of 500 S/cm or more.

7. The magnetic material according to claim 1, among all the particles of the layered material contained in the magnetic material, a proportion of single-layer particles and few-layer particles is 80% by volume or more.

8. The magnetic material according to claim 7, wherein a volume of the single-layer particles is larger than a volume of the few-layer particles.

9. The magnetic material according to claim 8, wherein a total mass of the single-layer particles is larger than a total mass of the few-layer particles.

10. The magnetic material according to claim 7, wherein a total mass of the single-layer particles is larger than a total mass of the few-layer particles.

11. The magnetic material according to claim 1, wherein a concentration of the magnetic metal ions in the magnetic material is 0.01 ppm or more.

12. A magnetic membrane or a magnetic structure comprising the magnetic material according to claim 6.

13. A magnetic article comprising the magnetic membrane or the magnetic structure according to claim 7.

14. A method for manufacturing a magnetic membrane or a magnetic structure, the method comprising:
bringing particles of a layered material including one or more layers into contact with magnetic metal ions; and
forming a membrane or a structure from a slurry including at least the particles of the layered material,
wherein the layer comprises a layer body represented by:
MₘXₙ
wherein M is at least one metal of Group 3, 4, 5, 6, or 7,
X is a carbon atom, a nitrogen atom, or a combination thereof,
n is not less than 1 and not more than 4, and
m is more than n but not more than 5, and
a modifier or terminal T is present on a surface of the layer body, wherein T is at least one selected from the group consisting of a hydroxyl group, a fluorine atom, a chlorine atom, an oxygen atom, and a hydrogen atom, and
the particles of the layered material have an average value of thicknesses of not less than 1 nm and not more than 10 nm.

15. The method for manufacturing a magnetic membrane or a magnetic structure according to claim 14, wherein the slurry contains the particles of the layered material in contact with the magnetic metal ions.

16. The method for manufacturing a magnetic membrane or a magnetic structure according to claim 14, wherein the membrane or the structure is formed containing the particles of the layered material and then the magnetic metal ions are brought into contact with the one or more layers.
